(19) United States
(12) Patent Application Publication
(10) Pub. No.: US 2023/0133851 A1
(43) Pub. Date: May 4, 2023

(54) AUTOMATED PUSH NOTIFICATIONS SYSTEM BASED ON MACHINE LEARNING

(71) Applicant: Message Notify Ltd., Tel Aviv (IL)

(72) Inventor: Liran BRENNER, Tel Aviv (IL)

(73) Assignee: Message Notify Ltd., Tel Aviv (IL)

(21) Appl. No.: 17/977,082

(22) Filed: Oct. 31, 2022

Related U.S. Application Data
(60) Provisional application No. 63/274,075, filed on Nov. 1, 2021.

(51) Int. Cl. H04L 67/55; H04L 67/50

(52) U.S. Cl. CPC H04L 67/55; H04L 67/535

(57) ABSTRACT

A computer-implemented method and system for the generation of automated push notifications directed to users of a website, comprising: retrieving, using software, data from a website; storing data from the website on a server; generating a plurality of combinations of data for a plurality of push notifications, wherein the data is adjusted by the software; transmitting the plurality of push notifications to a plurality of users, wherein the plurality of push notifications is transmitted at a specific time interval adjusted by the software; using the software, assessing a plurality of interactions of a plurality of users exposed to the plurality of push notifications by one or more of: a click through rate of the plurality of push notifications; and user behavior of the plurality of users.

### CROSS REFERENCE TO RELATED APPLICATIONS

The present application claims the benefit of prior U.S. Provisional Patent Application No. 63/274,075 filed on Nov. 1, 2021, incorporated by reference herein in its entirety.

### TECHNICAL FIELD OF THE INVENTION

The present invention relates generally to the generation of automated push notifications, in particular to adjusting content and time interval of push notifications based on the assessment of interactions of users exposed to such push notifications.

### BACKGROUND OF THE INVENTION

Many platforms, e.g. websites and online services, allow users to subscribe to push notifications. Push notifications, also referred to as server push notifications, are notifications that are delivered from software application to a computing device without a specific request from the client. Typically, a user has to opt in to receive alerts. Opt-in commonly takes place during the installation process, e.g. during the visit of a website. Users may manage alerts if they want to opt out of push notifications at a later point in time.

Software applications for push notifications allow a website owner to access the list of the subscribed users and send push notifications manually from the platform, e.g. a server, to the computing device of a user.

Commonly, users of a website can be classed into two types of users—new users and returning users. New users are visiting a website for the first time, for example as a result of advertising by marketing and sales via Internet traffic acquisition methods such as search engine optimization (SEO), Pay per click (PPC) and social networks. Returning users are thereby users who have already accessed a website and return to the website in subsequent visits.

It is well established that websites tend to have more new users and fewer returning users. However, users returning to a website they have previously visited tend to have a higher engagement—they view more content of a website per visit, and have higher visit durations. Returning users also tend to have higher conversion rates, e.g. users that return to a website are more likely to trigger a conversion event such as a subscription, a download or a purchase when they revisit a website. This consumer behavior of returning users may result in higher sales of products.

Thus, website owners and businesses have a high interest in encouraging new users of a website to become returning users of their websites.

### SUMMARY OF THE INVENTION

The following is a simplified summary providing an initial understanding of the invention. The summary does not necessarily identify key elements nor limit the scope of the invention, but merely serves as an introduction to the following description.

Embodiments of the present invention may provide businesses and website owners with a novel way to engage with users of a website and encourage users, in particular after a first time visit of a website, to return to a website, they have visited before.

Additionally, embodiments of the present invention may provide for the generation of automated push notifications, in particular to software for adjusting data and time interval for push notifications and for assessing interactions of users exposed to push notifications.

According to a first aspect, an embodiment of the present invention may provide a computer-implemented method for the generation of automated push notifications directed to a plurality of users of a website based on machine learning, including: retrieving, using software, data from the website; storing data from the website on a server; generating a plurality of combinations of data for a plurality of push notifications, wherein the data is adjusted by the software; transmitting the plurality of push notification to one or more users, wherein the plurality of push notifications is transmitted at a specific time interval adjusted by the software; and using the software, assessing a plurality of interactions of the plurality of users exposed to the plurality of push notifications by one or more of: a click through rate of the plurality of push notifications; and user behavior of the plurality of users.

According to an another aspect, an embodiment of the present invention may identify a system for the generation of automated push notifications directed to a plurality of users of a website based on machine learning, the system including: a computer; a processor; a server; and software; providing a set of instructions that, when executed, cause the computer processor to: retrieve, using software, data from a website; store data from the website on a server; generate a plurality of combinations of data for a plurality of push notifications, wherein the data is adjusted by the software; transmit the plurality of push notifications to the plurality of users, wherein the plurality of push notifications is transmitted at a specific time interval adjusted by the software; use the software, assessing a plurality of interactions of the plurality of users exposed to the plurality of push notifications by one or more of: a click through rate of the push notification; and user behavior of the plurality of users.

In some embodiments, the data of the plurality of push notifications is adjusted by the software to increase interaction of a plurality of users exposed to the plurality of push notifications.

In some embodiments, the plurality of push notifications are generated from the plurality of combinations of data by the generation of a plurality of prompts executed by the software.

In some embodiments, the specific time interval of the plurality of push notifications is adjusted by the software to increase interaction of a plurality of users exposed to the plurality of push notifications.

In some embodiments, the data from a website includes one or more of:

(a) content displayed on the website;
(b) source code of the website;
(c) social media content implemented on the website;
(d) search trends related to the website content; and
(e) website content in translated languages.

In some embodiments, the combination of data includes a title, a text and an image.

In some embodiments, the specific time interval for the transmission of a plurality of push notifications is based on one of: internet protocol address, and Greenwich Mean Time (GMT).

In some embodiments, the specific time interval is a preferred time of a day and is selected from the group including between 3:00 PM to 4.00 PM, between 9.00 AM to 10.00 AM, between 3.00 PM to 5.00 PM, between 4.00 PM to 7.00 PM, and between 2.00 PM to 7.00 PM.

In some embodiments, the specific time interval is a number of push notifications per week.

In some embodiments, the specific time interval is a number of push notifications per week selected from a group including of: 1 push notifications per week, 2 push notifications per week, 5 push notifications per week, 10 push notifications per week, 15 push notifications per week and 20 push notifications per week.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

Non-limiting examples of embodiments of the disclosure are described below with reference to figures listed below. The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings:

FIG. 1 depicts a system for generating automated push notifications, according to an embodiment of the present invention.

FIG. 2 depicts a high-level block diagram of an exemplary computing device which may be used with embodiments of the present invention.

FIG. 3 depicts generating automated push notifications, according to an embodiment of the present invention.

FIG. 4 depicts a screenshot of a website that may be used in the generation of an automated push notification, according to an embodiment of the present invention.

FIG. 5 depicts time windows for sending push notifications, according to an embodiment of the present invention.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

Embodiments of the present invention may improve content of push notifications by retrieving data from websites and providing users with customized push notifications, e.g. tailored to the content of a website for which a user has opted in to receive push notifications. Embodiments of the present invention may also provide content of push notifications that is adapted to the user's behavior to previously received push notifications.

The automated provision of tailored push notifications enables businesses and website owners to re-engage with first time website users using automated push notifications tailored to the content of a website visited by a user.

The term “website” may describe a collection of publicly accessible, interlinked web pages that share a single domain name. Websites can be created and maintained by an individual, group, business or organization to serve a variety of purposes. Together, all publicly accessible websites constitute the World Wide Web.

The term “meta tags” may describe snippets or portions of text that may describe an Internet web page's content, where the meta tags do not appear on the page as displayed in the user interface of a browser but only in the page's source code. Meta tags are essentially little content descriptors that help tell search engines what a web page is about. Meta tags may exist in the source code of a website, usually at the head of a page, and may be accessible by web developers or search engines.

The term “push notification” may describe a notification that is sent from a server via a notification application to a computing device without special request from a user (except possibly for a general advance permission given for such notifications to be sent). The push notification may be displayed to a user at a user interface of a computing device. Commonly a user may subscribe/unsubscribe to receive push notifications when visiting a website for the first time. Users that have subscribed to a push notification allow a server to push information to the user in form of a notification.

The term “push notification service handler” may describe software interface that is responsible for managing the subscription of a user to push notifications. The software can be implemented on a website and may provide a user with an interface that enables the user to subscribe for a push notification.

The term “server engine” is software that may receive subscriptions via the push notification service handler and may provide push notifications to be send to the device of a user.

Some embodiments include a system for the generation of automated push notifications directed to users of a website based on machine learning, including a computer; a processor; a server; and software; providing a set of instructions that, when executed, cause the computer processor to: retrieve, using software, content from the website; store content from the website on a server; generate a plurality of combinations of data for a push notification, wherein the data is adjusted by the software; transmit the plurality of push notifications to a plurality of users, wherein the plurality of push notifications is transmitted at a specific time interval adjusted by the software; and use the software, assessing a plurality of interactions of a plurality of users exposed to the plurality of push notifications by one or more of: a click through rate of the push notification; and user behavior.

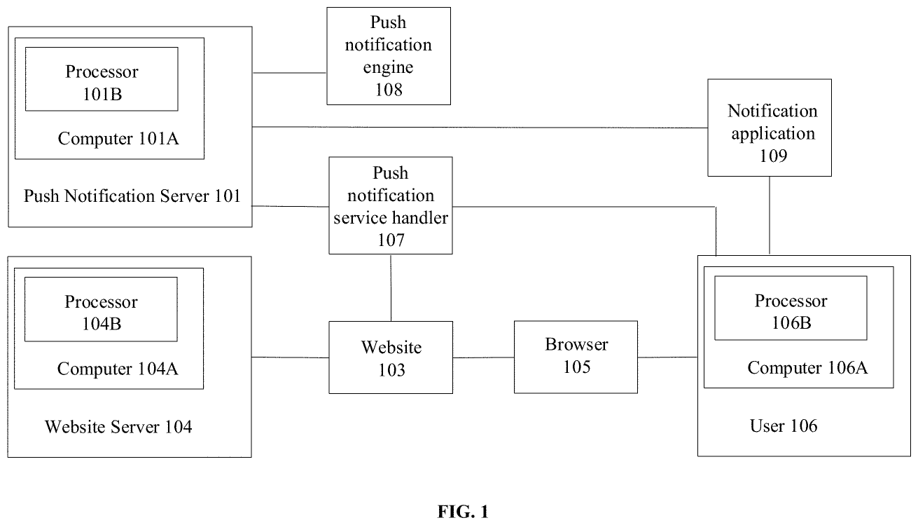

FIG. 1 shows an example for the generation of automated push notifications directed to users of a website based on machine learning.

As detailed in FIG. 1, user 106 may access a website, e.g. website 103, using browser 105, executed by processor 106B of computer 106A. Website 103 may include source code associated with push notification service handler 107. Push notification service handler 107 may present user 106 with a subscription interface for push notifications. When user 106 subscribes to push notifications using the subscription interface of push notification service handler 107, a unique device identifier for a device of the user may be stored in a database stored in push notification server 101.

As detailed in FIG. 1, an embodiment includes computer 101A that includes processor 101B and is connected to a push notification server 101. Server software, e.g. a server engine, may be executed by processor 101B. The push notification service handler 107, executed by processor 101B of computer 101A may be configured to access and retrieve data from a website, e.g. website 103. For example, data from a website, e.g. website 103, includes one or more of: content displayed on the website, source code of the website, social media content implemented on the website, search trends related to the website content and website content in translated languages. Website 103 may be hosted on a website server 104 connected to computer 104A including processor 104B such that website code and definitions are transmitted from server 104 to computer 104A for execution and display by computer 104A. Data retrieved from a website 103 may be stored on push notification server 101.

Computer 101A may generate push notifications using data stored by push notification server 101. Processor 101B of computer 101A may be configured to execute push notification engine 108. Processor 101B of computer 101A may be configured, e.g. using a server engine, to generate prompts that are executed by push notification engine 108. Prompts may be commands that include excerpts of data from websites, e.g. website 103, stored at push notification server 101.

Prompts may be used by push notification engine 108 in the generation of push notifications. Push notification engine 108 may be software that allows a device such as computer 101A to generate a push notification when provided with a prompt and data stored on push notification server 101. In some embodiments, processor 101B of computer 101A sends a plurality of prompts to push notification engine 108 resulting in a plurality of push notifications generated by push notification engine 108. Push notifications may be stored on push notification server 101.

When executed by processor 101B of computer 101A, push notification handler 107 transmits push notifications stored on push notification server 101 to user 106. A push notification may be displayed by computer 106A to user 106 in form of a push notification. Alternatively, when executed by processor 101B of computer 101A, a push notification may be transmitted to a notification application 109, e.g. Apple's push notification service or the Google cloud messaging service. The notification application 109 may then send the notification to a computer 106A of user 106. The computer of a user, e.g. computer 106A of user 106 may be identified by a unique device identifier, that is stored on a server, e.g. push notification server 101, after subscription of a user to receive push notifications for a website. In some embodiments, the push notification is sent from a notification application to a browser, e.g. browser 105 of user 106.

User 106 may interact with a push notification, e.g. user 106 may click on a push notification when it is displayed to the user. In some embodiments, push notification handler 107 or notification application 109 is configured to assess the interaction of user 106 with a push notification. Assessment of the interaction of a user 106 with a push notification may include registering a click by user 106 on a push notification. In some embodiments, a click by a user 106 on a push notification is tracked by a notification application 109 and metrics of clicks on push notifications are provided from the notification application 109 to the push notification server 101.

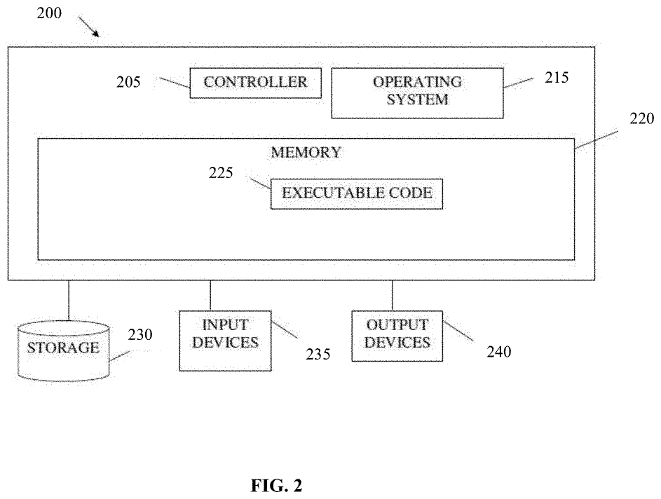

The computer may be a computer system for example as shown in FIG. 2. FIG. 2 shows a high-level block diagram of an exemplary computing device which may be used with embodiments of the present invention. Computing device 200 may include a controller or computer processor 205 that may be, for example, a central processing unit processor (CPU), a chip or any suitable computing device, an operating system 215, a memory 220, a storage 230, input devices 235 and output devices 240 such as a computer display or monitor displaying for example a computer desktop system. Each of modules and equipment such as Internet browsers, software programs computer desktop system, servers, server software and other modules discussed herein may be or include, or may be executed by, a computing device such as included in FIG. 2, although various units among these modules may be combined into one computing device.

Operating system 215 may be or may include code to perform tasks involving coordination, scheduling, arbitration, or managing operation of computing device 200, for example, scheduling execution of programs. Memory 220 may be or may include, for example, a Random Access Memory (RAM), a read only memory (ROM), a Flash memory, a volatile or non-volatile memory, or other suitable memory units or storage units. Memory 220 may be or may include a plurality of different memory units. Memory 220 may store for example, instructions (e.g. code 225) to carry out a method as disclosed herein, and/or data such as low-level action data, output data, etc.

Executable code 225 may be any application, e.g. a program, process, task or script. Executable code 225 may be executed by controller 205 possibly under control of operating system 215. For example, executable code 225 may be one or more applications performing methods as disclosed herein. In some embodiments, more than one computing device 200 or components of device 200 may be used. One or more processor(s) 205 may be configured to carry out embodiments of the present invention by for example executing software or code. Storage 230 may be or may include, for example, a hard disk drive, a floppy disk drive, a Compact Disk (CD) drive, a universal serial bus (USB) device or other suitable removable and/or fixed storage unit. Data described herein may be stored in a storage 230 and may be loaded from storage 230 into a memory 220 where it may be processed by controller 205.

Input devices 235 may be or may include a mouse, a keyboard, a touch screen or pad or any suitable input device or combination of devices. Output devices 240 may include one or more displays, speakers and/or any other suitable output devices or combination of output devices. Any applicable input/output (I/O) devices may be connected to computing device 200, for example, a wired or wireless network interface card (MC), a modem, printer, a universal serial bus (USB) device or external hard drive may be included in input devices 235 and/or output devices 240.

Embodiments of the invention may include one or more article(s) (e.g. memory 220 or storage 230) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

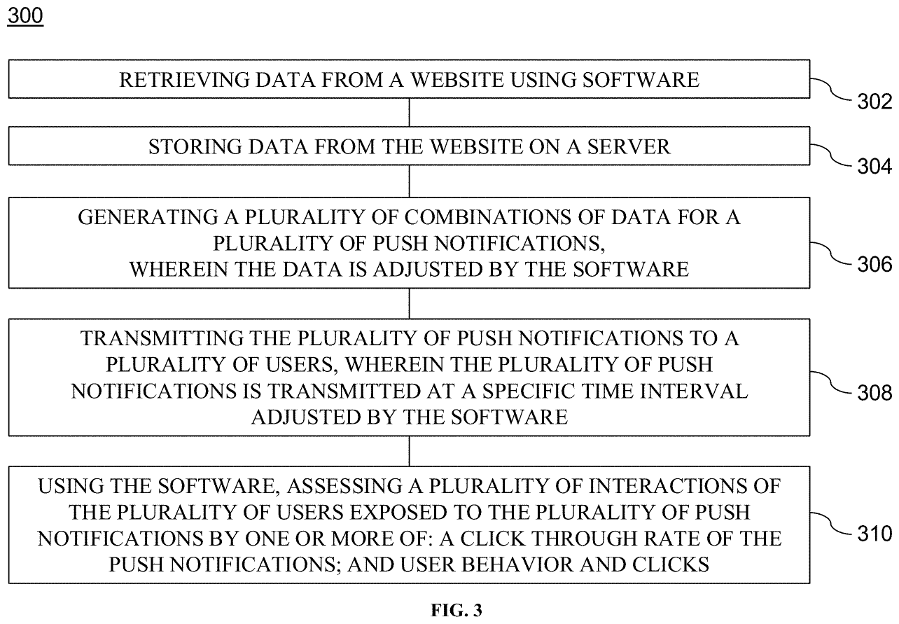

FIG. 3 shows a method 300 for the generation of automated push notifications directed to users of a website based on machine learning, according to some embodiments of the invention.

According to some embodiments, method 300 includes retrieving data, using software, from the website (step 302, e.g. executed by processor 101B of computing device 101A shown in FIG. 1 herein). Software for retrieving data from a website (e.g. website 103 of FIG. 1) can be a push notification service handler (e.g. push notification service handler 107 of FIG. 1).

In various embodiments, the data received from a website includes one or more of: content displayed on the website, source code of the website for example HyperText Markup Language (HTML) source code, social media content implemented on the website, search trends based to the website content and website content in translated languages. Content in translated languages may include content of a website that is provided to users in alternative languages, e.g. a website that has a main language of English may also provide content in alternate languages such as Chinese or German. In some embodiments, content of the source code of a website includes meta tags. Meta tags form part of the source code and provide additional information about the webpage than can be used e.g. by search engines. For example, a meta tag of an Italian restaurant website can be “Italian food”, “pasta recipe” or “pizza topping”. In various embodiments, data from the website may include data obtained from a website in form of text (for example source code), images (for example jpeg formatted images) and videos (for example formatted in the mp4 format). Data of the website may be dynamically retrieved, for example, data from a website may be retrieved once per hour, once per day, once per week, one every month.

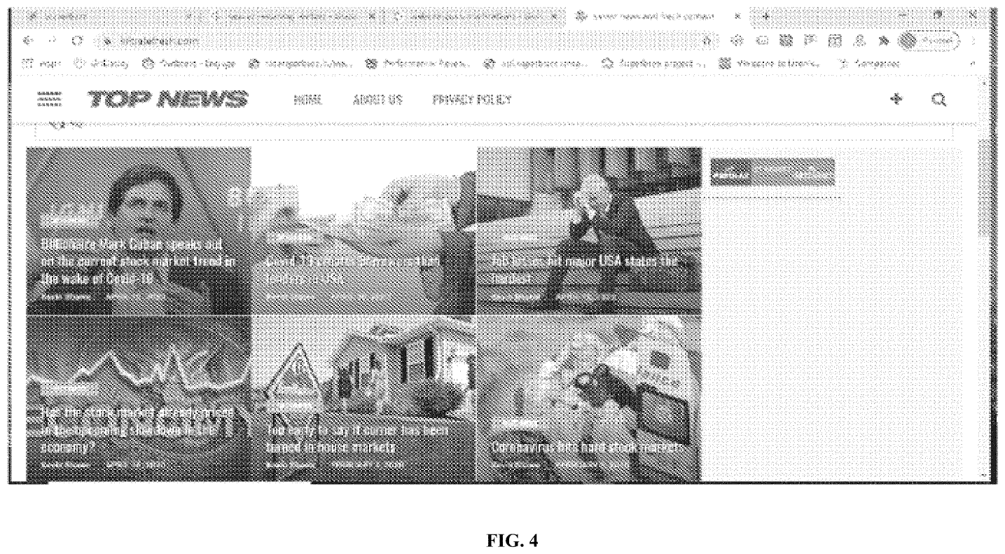

Turning to FIG. 4, FIG. 4 is an example of a display version of website, which may have corresponding code or other data provide by a server and executed by a user computer. Data of the website can be retrieved using software, e.g. push notification service handler 107. For example, the software may retrieve the news headline “Billionaire Mark Cuban speaks out on the current stock market trend in the wake of Covid-19”.

According to some embodiments, method 300 includes storing data from the website on a server (FIG. 3, step 304). For example, a push notification software may retrieve data such as source code, images and videos from a website and stores the data on a server, e.g. push notification server 101 as shown in FIG. 1. In some embodiments, data retrieved from the website is stored on the server in combination with a time stamp to assess the age of data obtained from a website. Data retrieved from a website may replace data with an earlier time stamp on the server, e.g. push notification server 101 as shown in FIG. 1. In addition, data from a website may be stored on a server in combination with keywords, that describe the industry or the topic of the website. For example, meta tags of a website may be used as keywords.

According to some embodiments, method 300 includes generating a plurality of combinations of data for a plurality of push notifications, wherein the data is adjusted by the software (FIG. 3, step 306). Data received from the website and stored on the server, e.g. server 101, may be used by software, for example push notification engine 108 (shown in FIG. 1) such as the Generative Pre-trained Transformer 3 (GTP-3 engine) in the generation of a push notification. In some embodiments, the software, e.g. push notification engine 108, creates a push notification by generating a title of a push notification, a body of a push notification and an image of a push notification from data received from a website, e.g. as disclosed in step 302 of method 300. In some embodiments, a push notification created by the software, e.g. push notification engine 108, includes generating an icon of the push notification from data received from the website. In an embodiment, an icon of the push notification may be an image. The GTP-3 engine is software that uses artificial intelligence in the generation of human-like text. Thus, the GTP-3 engine, forming part of the push notification engine 108, may be used to generate title and body of a push notification. Thereby, the GTP-3 engine is provided with data stored on push notification server 101 of FIG. 1. In some embodiments, the plurality of push notifications are generated from the plurality of combinations of data stored on the server. In the generation of a push notification, push notification engine 108 (shown in FIG. 1), e.g. GTP-3 engine, may receive a prompt. The prompt may then be executed by the push notification engine 108.

In some embodiments, the combination of data that is provided to the GTP-3 engine is a prompt. In some embodiments, a prompt is an excerpt of data retrieved from a website (in step 302) stored on push notification server 101 of FIG. 1 (in step 304). A prompt is used by the push notification engine 108 in the production of a push notification. The content of the push notification is thereby highly dependent on the text initially provided within the prompt, as outlined below.

Turning to FIG. 1, prompts may be generated by software, e.g. a server engine, executed by processor 101B of computer 101A. For example, a server engine may access data received from a website stored on server 101 and generates combination of data for a website in form of a prompt. The prompt includes content of a website, e.g. website 103. In some embodiments, the server engine generates a plurality of combinations of data retrieved from the website in form of a plurality of prompts that can be executed by a push notification engine and provides a plurality of push notifications.

In prior art systems, prompts included only a Uniform Resource Locator (URL) website address. However, in some embodiments of the present invention, prompts are generated using data, e.g. content of a website, retrieved from a specific website for which a creation of a push notification is thought.

Thus, a prompt according to embodiments of the present invention may include specific data from a website, e.g. a prompt may describe a specific product displayed on a website that is desired to be included in the push notification. Turning to FIG. 1, a server engine executed by processor 101B may thereby extract excerpts of data retrieved from a website (in step 302), e.g. parts of a sentence, a subject, a name or an amount/a value. The excerpts of data may then be used in the generation of a prompt.

In some embodiments, prompts of the present invention generated from data or from excerpts of data include a specific syntax. For example, a prompt may include four parts and may be referred to herein as “SuperBuzz prompt”:
a question, e.g. a tag line, directed to a location of a product;
an answer, e.g. in form of a tag line, to the question of the location including a website address to the website that shows the product;
a brief description, such as one or two tag lines, defining the product or specifying a feature of the product; and
an exclamation, e.g. in form of a tag line, including a link to the website that shows the product.

For example, a prompt (SuperBuzz prompt) for “baby monitors” generated by computer 101A may recite:

{“prompt”: “Where can I find the best Baby Monitors with Longest Range\n\n”, “completion”: “You can find the best Baby Monitors with Longest Range at “website address” Whether you live in large homes or not, long distances baby monitors are necessary. Here are 13 best baby monitor with longest range. Just go to “website address” and take a look! ###”}

As shown above, the prompt may include the question: “Where can I find the best Baby Monitors with Longest Range”, an answer to the question “You can find the best Baby Monitors with Longest Range at “website address””, details specifying the product “Whether you live in large homes or not, long distances baby monitors are necessary. Here are 13 best baby monitor with longest range.” and an exclamation referring to the website of the product “Just go to “website address” and take a look!”.

Images for a push notification may be generated from data received from a website using an image creation tool that is accessed by push notification engine 108. In an embodiment, images for a push notification may be created by providing an image creation tool with data corresponding to the data used in the generation of the title and body of a push notification.

In a second example, the server engine may be configured to extract phrases of headlines from the retrieved data from a website: The headline “Billionaire Mark Cuban speaks out on the current stock market trend in the wake of Covid-19” may be transformed into tag lines, e.g. questions and phrases relating to extracted phrases of the headline. The headline could lead to the provision of questions or phrases (tag lines) such as “See what Mark Cuban speaks about?” and “See top news with Covid-19”. The server engine may be configured to extract parts of a sentence, subject, name or amounts from data retrieved from a website stored on the server in the generation of a prompt. The generated prompt is then used by a push notification engine, e.g. the GTP-3 engine. The push notification engine, e.g. the GTP-3 engine generates a push notification using the input in form of a prompt.

In Table 1, example tag lines for the website “keedoz.com” have been generated using three different artificial intelligence engines. The website “keedoz.com” provides content for expectant parents and parenting. Push notification engines GPT-3 and Ai21 have been requested to generate text in form of tag lines for push notifications based on a prompt relating to the web address “https://keedoz.com”. In addition, the GPT-3 engine has been provided with a prompt using a syntax as disclosed herein, referred to as Superbuzz prompt.

As can be seen from the generated tag lines of a push notification disclosed in Table 1, tag lines generated using the GPT-3 engine (referred to as Not Engineered GPT-3 response) using the web address “https://keedoz.com” as the prompt led to the generation of tag lines referring to the term “shopping”. Tag lines created using the Ai21 engine using the web address “https://keedoz.com” resulted in tag lines referring to the terms “play” and “games”. Neither of the engines GTP-3 and Ai21 provided with the prompt referring to the web address “https://keedoz.com” generated a tag line that was refers to the term “parenting”. In contrast, the GPT-3 engine using a SuperBuzz prompt as described herein led to the provision of tag lines referring to the term “parenting”. Thus, tag lines of push notifications generated using the SuperBuzz prompt in combination with the GPT-3 engine led to a precise tag line that closely refer to the content of the website keedoz.com. The SuperBuzz prompt can therefore provide tag lines within push notifications that are closely tailored to the content of a website, or closely tailored to a product shown on a website.

TABLE 1
Example comparison of tag lines generated from different prompts

| Not Engineered GPT-3 | | |
|---|---|---|
| response | A121 | SuperBuzz |
| A better way to shop | Get paid to play games | The ultimate parenting |
| online | | resource |
| The smarter way to | Get paid to play great | Everything you need to |
| shop | games | know about parenting |
| Shop smarter with | Get paid to play fun | The one shop for |
| Keedoz | games | parenting information |
| Find what you’re | Get paid to play | The go-to source for |
| looking for with | awesome games | parenting advice |
| Keedoz | | |
| Get the best deals | Get paid to play free | The best parenting |
| With Keedoz | games | resource on the web |

A plurality of tag lines, e.g. 10-15 tag lines, may be created for data received from a website and may then be used in the generation of a plurality of push notifications, e.g. 10-15 push notifications for a website. The generated push notifications may then be sent to a plurality of users, e.g. groups of users, to assess the user behavior of users provided with the push notifications as outlined below.

Each push notification generated by a prompt in the syntax disclosed herein using the GTP-3 engine may include a title, a body and an image. A plurality of combinations of push notifications generated by the software may be stored on a server, e.g. push notification server 101 as shown in FIG. 1. Each of the plurality of push notifications may also be linked to the website that provided data for the generation of the push notification.

In some embodiments, method 300 includes transmitting the plurality of push notifications to a plurality of users, wherein the plurality of push notifications is transmitted at a specific time interval adjusted by the software (FIG. 3, step 308).

In some embodiments, software, e.g. the server engine of push notification server 101, transmits the plurality of push notifications to the plurality of users. In some embodiments, the transmittal of the plurality of push notifications stored on a server, e.g. the push notification server 101, proceeds via executing a push notification protocol, e.g. by a server engine, of push notification server 101. In an embodiment, a push notification protocol may be known in the art, e.g. Push API. A push notification protocol allows to send push notifications from a server to an application that can be accessed by a user using a computing device, e.g. using browser 105 as outlined in FIG. 1. In some embodiments, the plurality of push notifications may be transmitted to the plurality of users after a specific time interval after each user of the plurality of users has accessed a website. In some embodiments, the plurality of push notifications may be transmitted to the plurality of users after a specific time interval after each user of the plurality of users has accessed a website and subscribed to receive push notifications for the website.

When a push notification is sent to a user, the software, e.g. the server engine or the push notification service handler, may store parameters for the push notification on a server in combination to the unique device identifier referring to the device, e.g. a computer of a user. In various embodiments, parameters stored for a push notification transmitted to a user include, for example, the time of transmittal of the push notification to a user, the time a user interacted with the push notification, e.g. by clicking on the received push notification, the type of interaction e.g. whether a specific link within the message was clicked or whether a specific button on the push notification was clicked, e.g. button “Close”, or “Learn More”, and interaction of a user on the corresponding website that has been referred to in the push notification. The interaction of a user on the corresponding website on which behalf the push notification was sent, e.g. in form of clicks, may be retrieved by the push notification service handler and stored on the push notification server and allows to connect a conversion event triggered by a user, e.g. a sale, with a push notification received by a user and provides information on the user behavior on a website in response to a received push notification. The received interaction of a user to a received push notification allows the software, e.g. the server engine or the push notification service handler, to assess the interaction of a user to a push notification. One or more interactions of a user to received push notifications may form a metrics for a user and enable software, e.g. the server engine or the push notification service handler, to assess the one or more interactions. For example, push notifications that lead to a conversion event for a user may be sent to other users whereas push notifications that are not opened by a user, do not lead to a conversion event triggered by a user or may lead to a user revoking their opt in for push notifications may not be sent to another user.

In some embodiments, the specific time interval of a push notification sent to a plurality of users is adjusted by software, e.g. push notification service handler 107 as shown in FIG. 107, to increase interaction of the plurality of users exposed to the push notification.

In various embodiments, the specific time interval for the transmission of a push notification is based on one of: (a) internet protocol (IP) address, and (b) time according to Greenwich Mean Time (GMT). The IP address for a user subscribed to push notifications may allow to identify the geographic location of the browser-connected computing device and may refer to a specific time zone.

In various embodiments, the specific time interval is a preferred time of a day and is selected from a group including: between 3.00 PM to 4.00 PM, between 9.00 AM to 10.00 AM, between 3.00 PM to 5.00 PM, between 4.00 PM to 7.00 PM, and between 2.00 PM to 7.00 PM.

In some embodiments, the specific time interval is a number of push notifications per week. In some embodiments, the specific time interval is a number of push notifications per week selected from a group including: 1 push notifications per week, 2 push notifications per week, 5 push notifications per week, 10 push notifications per week, 15 push notifications per week and 20 push notifications per week.

In some embodiments, method 300 includes, using the software, assessing a plurality of interactions of the plurality of users exposed to the plurality of push notifications by one or more of: a click through rate of the plurality of push notifications; and user behavior of the plurality of users (FIG. 3, step 310).

In some embodiments, the plurality of a push notifications sent to the plurality of users are assessed based on the interaction of the plurality of users with the received push notification.

In some embodiments, a plurality of interaction of the plurality of users is assessed by evaluating the click through rate of the plurality of push notifications. The click through rate may be determined as the ratio of the number of users who clicked on a push notification to the number of users who have received a push notification.

For example, a push notification has been sent to 100 users. Out of the 100 users, 20 have interacted with the push notification by clicking on the push notification. The resulting click-through rate for this case is 20/100 equal to 20%.

To assess the interaction of users to the content of a push notification, a push notification of the plurality of push notifications may be sent to a group of the plurality of users. Then, interactions of the group of the plurality of users may be assessed by evaluating the click through rate for the push notification of the plurality by the group of the plurality of users. A push notification that has been assessed to provide a high click through rate may be sent to other users of the plurality of users. A push notification that has been assessed to have a low click through rate may not be sent to other users of the plurality of users. A high click through rate may thereby be refer to a click through rate between 1% to 10%.

The software, e.g. the server engine or the push notification service handler, may assess interactions of a plurality of users for a push notification of the plurality of push notifications in relation to the time of the day. To assess interactions for a push notification in relation to the time of the day, a push notification of the plurality of push notifications may be sent to a group of the plurality of users at a certain time of the day.

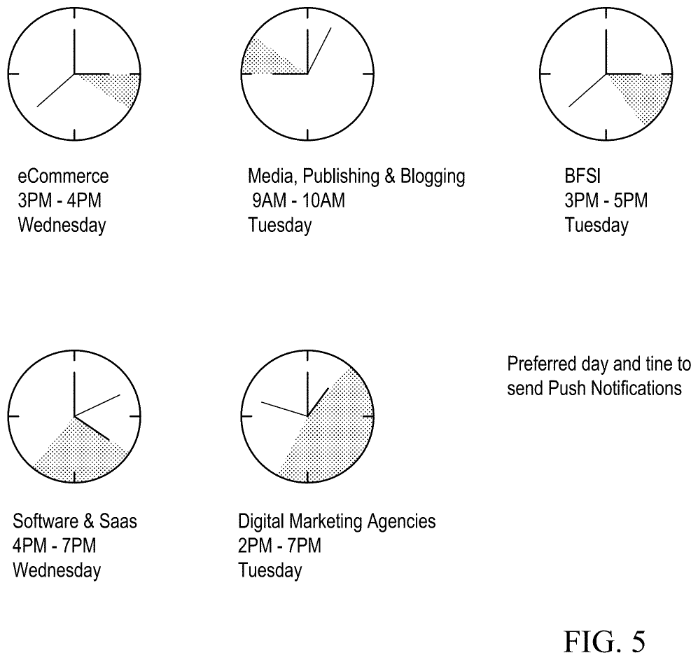

FIG. 5 presents example time intervals in which users of a website that have received a push notification have shown a high click through rate when exposed to a push notification, according to some embodiments. The time interval for a high click through rate of a push notification is highly dependent on the content of a website. For example, push notifications sent to users that have previously accessed a website, e.g. by digital marketing agencies, have shown a high click through rate when received on a Tuesday between 2 pm and 7 pm. The software, e.g. the server engine or the push notification service handler, may use keywords, e.g. meta tags, stored with the data from a website on the server to allocate a time of the day or time interval as a starting point for sending a first push notification. Then, the interactions of the group of the plurality of users may be assessed by evaluating the click through rate for the push notification of the plurality by the group of the plurality of users for a certain time of the day or a time interval. The software may vary the time of the day or the time interval for a push notification based on assessing the click through rate of the users that have been exposed to the push notification.

For example, a plurality of users that have subscribed to receiving push notifications from a website may be divided into three groups. Each of the groups may be exposed to a specific push notification and interactions of each group of users with the push notification may be assessed, e.g. by evaluating the click through rate of the push notifications in each group of users and by evaluating the time of the day or time of the week. A push notification that has been assessed to have a low click through rate within a group of users may not be sent to other users of the plurality of users. A high click through rate may thereby refer to a click through rate of 3% or greater 3%. A low click through rate may refer to a click through rate of less than 3%. Push notification service handler may store interactions of users exposed to push notifications at a server, e.g. push notification server 101 as shown in FIG. 1.

Some embodiments include using the software, adjusting data of the plurality of push notifications to increase interaction of the plurality of users exposed to the plurality of push notifications.

Interaction data retrieved for a plurality of users of a website on which behalf a plurality of push notifications are sent may be used to increase interaction with the plurality of users in subsequent push notifications. Within the retrieved interaction data, a push notification service handler may identify specific time intervals for sending push notifications that have previously led to a high user interaction, e.g. a high click through rate. Specific time intervals for push notifications for a website may be used in step 304 as shown in FIG. 3 in the transmitting step of subsequent push notifications.

For example, retrieved interaction data may be used to assess the best number of push notifications in a specific time interval. The push notification handler may divide a plurality of users that have opted in for push notifications for a certain website into groups (A, B and C) of users. Each group of users may receive a specific number of push notifications. For example, a user of group A may receive 5 push notifications per week, a user of group B may receive 10 push notifications per week, and a user of group C may receive 15 push notifications per week. A push notification service handler may receive user interactions for each group and may assess the interactions of each user group after each cycle of the time interval. For example, the number of subscriptions to push notifications is monitored to identify whether users decide to opt out of push notifications as a result of a number of received push notifications. For example, a push notification service handler may retrieve for each user group the number of clicks on the push notification after a week and the number of users that have clicked on at least one push notification and are referred to as active users. Table 2 discloses example numbers of push notifications, clicks on push notifications after a week and the number of active users for example user groups A, B and C:

TABLE 2
Example user interactions retrieved at a push notification
service handler

| | Group A | Group B | Group C |
|---|---|---|---|
| Number of push notifications | 5 | 10 | 15 |
| per week | | | |
| Clicks generated per week | 1200 | 1500 | 1600 |
| Number of active users | 70% | 60% | 30% |

Push notification service handler may evaluate the retrieved user interactions. In some embodiments, a parameter for assessing the user interactions for different time intervals is the ratio of clicks generated per week to the number of active users. For the case shown in table 2, the best ratio of clicks generated per week to the number of active users is observed for users of group B and the number of subsequent push notifications transmitted at a specific time interval may be adjusted to 10 push notifications per week. As a result, the push notification service handler may adjust the interval for subsequent push notifications for users of group A and group C to 10 push notifications per week.

Alternatively, a plurality of interactions of a plurality of users in response to a push notification may be assessed by the user behavior of a plurality of users. For example, in this context, user behavior may describe assessing whether a plurality of users exposed to a plurality of push notifications have created a user account at the website on which behalf the push notification was sent. Additionally, assessing user behavior may describe assessing whether a plurality of users exposed to a plurality of push notifications have a conversion event at a website, e.g. the purchase of an item on a website or the subscription to a newsletter, on which behalf the push notification was sent. A conversion event on a website by a user may thereby be linked to a push notification received by a user by identifying a match of a unique device identifier for a computer of a user in a push notification database stored at the push notification server and in a database for conversion events, e.g. a database that records purchases on a website in relation to the computer that has been used in the conversion event, e.g. by recording the unique device identifier for a computer used by a user during a purchase. These user behavior parameters also allow to assess the user behavior in response to a plurality of push notifications.

Push notifications may be adjusted by software, e.g. push notification service handler or server engine, based on metrics received for a push notification, such as click through rate or user behavior. New push notifications may be generated by evaluating received metrics. For example, a first push notification X includes the following content and has been sent to a group of users Y:

Body—A comprehensive resource for parents, with articles on everything from baby care to child development
Title—Keedoz.com is a comprehensive resource for parents, with articles on everything from breastfeeding to potty training.

In a series of new push notifications the title of first push notification X may be altered and software, e.g. push notification service handler or server engine, may generate push notifications, e.g. example push notifications A, B and C, that are derived from the first push notification X:

Example Push Notification A:

Body—A comprehensive resource for parents, with articles on everything from baby care to child development.
Title—Keedoz.com is packed full of useful articles on every aspect of parenting, from choosing the right childcare to dealing with tantrums.

Example Push Notification B:

Body—A comprehensive resource for parents, with articles on everything from baby care to child development.
Title—Keedoz.com is the perfect place to find information on all aspects of parenting, from pregnancy to raising teenagers.

Example Push Notification C:

Body—A comprehensive resource for parents, with articles on everything from baby care to child development.
Title—Keedoz.com is the perfect place to find advice and information on all aspects of parenting, from pregnancy to childcare to dealing with discipline issues.

In the example mentioned above, the title of the first push notification X has been amended in push notifications A-C. New generated push notifications A-C may be transmitted to the group of users Y and metrics, such as click through rate or user behavior for the group of users, may be received by software, e.g. the server engine of push notification server 101. Metrics for push notifications A-C may then be compared with metrics obtained for first push notification X to identity a push notification that led to the highest user interaction. The highest user interaction may be assessed by comparing metrics for push notifications A-C and X, e.g. the highest click through rate or user behavior received for a push notification. A push notification assessed to have the highest user interaction may then be sent to a larger audience, e.g. group of users Z.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What claimed is:

1. A computer-implemented method for the generation of automated push notifications directed to a plurality of users of a website, the method comprising:
retrieving, using software, data from the website;
storing data from the website on a server;
generating a plurality of combinations of data for a plurality of push notifications,
wherein the data is adjusted by the software;
transmitting the plurality of push notifications to a plurality of users,
wherein the plurality of push notifications is transmitted at a specific time interval adjusted by the software; and
using the software, assessing a plurality of interactions of the plurality of users exposed to the plurality of push notifications by one or more of:
a click through rate of the plurality of push notifications; and
user behavior of the plurality of users.

2. A method as in claim 1, wherein the data of the plurality of push notifications is adjusted by the software to increase interaction of the plurality of users exposed to the plurality of push notifications.

3. A method as in claim 1, wherein the plurality of push notifications are generated from the plurality of combinations of data by the generation of a plurality of prompts executed by the software.

4. A method as in claim 1, wherein the specific time interval of the plurality of push notifications is adjusted by the software to increase interaction of the plurality of users exposed to the push notification.

5. A method as in claim 1, wherein the data from a website comprises one or more of:
(a) content displayed on the website;
(b) source code of the website;
(c) social media content implemented on the website;
(d) search trends related to the website content; and
(e) website content in translated languages.

6. A method as in claim 1, wherein the combination of data comprises a title, a text and an image.

7. A method as in claim 1, wherein the specific time interval for the transmission of the plurality of push notifications is based on one of:
(a) internet protocol address, and
(b) Greenwich Mean Time (GMT).

8. A method as in claim 1, wherein the specific time interval is a preferred time of a day and is selected from a group consisting of: between 3.00 PM to 4.00 PM, between 9.00 AM to 10.00 AM, between 3.00 PM to 5.00 PM, between 4.00 PM to 7.00 PM, and between 2.00 PM to 7.00 PM.

9. A method as in claim 1, wherein the specific time interval is a number of push notifications per week.

10. A method as in claim 1, wherein the specific time interval is a number of push notifications per week selected from a group consisting of: 1 push notification per week, 2 push notifications per week, 5 push notifications per week, 10 push notifications per week, 15 push notifications per week and 20 push notifications per week.

11. A system for the generation of automated push notifications directed to users of a website, the system comprising:
a computer;
a processor;
a server; and
software;
providing a set of instructions that, when executed, cause the computer processor to:
retrieve, using software, data from the website;
store data from the website on a server;
generate a plurality of combinations of data for a plurality of push notifications,
wherein the data is adjusted by the software;
transmit the plurality of push notifications to a plurality of users,
wherein the plurality of push notifications is transmitted at a specific time interval adjusted by the software; and
assess a plurality of interactions of the plurality of users exposed to the plurality of push notifications by one or more of:
a click through rate of the plurality of push notifications; and
user behavior of the plurality of users.

12. A system as in claim 11, wherein the data of the plurality of push notifications is adjusted by the software to increase interaction of the plurality of users exposed to the plurality of push notifications.

13. A system as in claim 11, wherein the plurality of push notifications are generated from the plurality of combinations of data by the generation of a plurality of prompts executed by the software.

14. A system as in claim 11, wherein the specific time interval of the plurality of push notifications is adjusted by the software to increase interaction of the plurality of users exposed to the plurality of push notifications.

15. A system as in claim 11, wherein the data from a website comprises one or more of:
(f) content displayed on the website;
(g) source code of the website;
(h) social media content implemented on the website;
(i) search trends related to the website content; and
(j) website content in translated languages.

16. A system as in claim 11, wherein the combination of content comprises a title, a text and an image.

17. A system as in claim 11, wherein the specific time interval for the transmission of the plurality of push notifications is based on one of:
(a) internet protocol address, and
(b) Greenwich Mean Time (GMT).

18. A system as in claim 11, wherein the specific time interval is a preferred time of a day and is selected from a group consisting of: between 3.00 PM to 4.00 PM, between 9.00 M to 10.00 AM, between 3.00 PM to 5.00 PM, between 4.00 PM to 7.00 PM, and between 2.00 PM to 7.00 PM.

19. A system as in claim 11, wherein the specific time interval is a number of push notifications per week.

20. A system as in claim 11, wherein the specific time interval is a number of push notifications per week selected from a group consisting of: 1 push notifications per week, 2 push notifications per week, 5 push notifications per week, 10 push notifications per week, 15 push notifications per week and 20 push notifications per week.
